(19) United States
(12) Patent Application Publication
(10) Pub. No.: US 2014/0004245 A1
(43) Pub. Date: Jan. 2, 2014

(54) PET FOOD FROSTING/ICING COMPOSITION

(71) Applicant: Andrew E. Colsky, Arlington, VA (US)

(72) Inventor: Andrew E. Colsky, Arlington, VA (US)

(21) Appl. No.: 13/930,526

(22) Filed: Jun. 28, 2013

Related U.S. Application Data
(60) Provisional application No. 61/667,151, filed on Jul. 2, 2012.

(51) Int. Cl. A23K 1/18

(52) U.S. Cl. CPC A23K 1/18
USPC 426/583

(57) ABSTRACT

A yogurt based pet food composition includes a dry ingredients mixture composed of dry powdered yogurt, dry powdered maltodextrin, dry powdered starch, and dry powdered guar gum.

### CROSS REFERENCE TO RELATED APPLICATION

This application claims the benefit of U.S. Provisional Application Ser. No. 61/667,151, entitled “PET FOOD FROSTING/ICING COMPOSITION,” filed Jul. 2, 2012.

### BACKGROUND OF THE INVENTION

1. Field of the Invention

The invention relates to a pet food. More particularly, the invention relates to frosting and icing compositions used in the manufacture of pet food products.

2. Description of the Related Art

As pets develop more important roles within our households, the desire to provide pets with foods offering high nutritional value combined with aesthetically pleasing designs has led to the development of gourmet pet food shops. These shops commonly offer food products that resemble human desserts, but are made with products providing pet specific nutritional characteristics.

However, these pet specific food products require very different storage, processing and nutritional characteristics than their human counterparts. The only product previously available as a frosting/icing was a product formulated for humans that was never intended to meet the nutritional needs of pets. Additionally, the previous product could not be shipped, transported, or stored in high heat conditions. In particular, these prior art frostings and icings melted when the temperature rose to a certain point, for example, over 90° F., This limitation ultimately made such products unusable during the summer months when shipping requires that these products be exposed to high temperatures. If one did wish to ship the products during such high temperature months they would incur excessive shipping costs that are associated with shipment in refrigerated carriers. It is appreciated that the melting occurred because the products were substantially fat based products, which have a tendency to melt at relatively low temperatures. Prior to the current invention of frosting/icing, pet food shops lacking any alternative product, used human foods in their manufacture of pet treats, although it is well documented that human foods often produce negative effects in animals. In particular, these pet shops have been using frosting/icings formulated for humans, which ate often made primarily of sugars and fats, and such foods are not necessarily healthy for pets.

The present invention addresses these concerns and overcomes them by providing icing and frosting products on pet foods which are fat free and thus dry, hard and remain hard regardless of the temperature to which they are exposed. The pet foods are human quality but are specifically formulated for pets.

### SUMMARY OF THE INVENTION

It is, therefore, an object of the present invention to provide a yogurt based pet food composition comprising a dry ingredients mixture composed of dry powdered yogurt, dry powdered maltodextrin, dry powdered starch, and dry powdered guar gum.

It is also an object of the present invention to provide a pet food composition including water which is added to the dry ingredients mixture to achieve a desired consistency.

It is another object of the present invention to provide a pet food composition wherein the dry ingredients mixture includes approximately 27.5% to 37.5% by weight dry powdered yogurt, approximately 27.5% to 37.5% by weight dry powdered maltodextrin, approximately 27.5% to 37.5% by weight dry powdered starch and approximately 2.5% to 4.5% by weight dry powdered guar gum.

It is a further object of the present invention to provide a pet food composition wherein the dry ingredients mixture includes approximately 32.5% by weight dry powdered yogurt, approximately 32.5% by weight dry powdered maltodextrin, approximately 32.5% by weight dry powdered starch and approximately 2.5% by weight dry powdered guar gum.

It is also an object of the present invention to provide a pet food composition wherein two cups of the dry ingredients mixture are mixed with between approximately ⅓ cup water and ⅔ cup water.

It is another object of the present invention to provide a pet food composition wherein the dry ingredients mixture includes approximately 20% to 30% by weight dry powdered yogurt, approximately 45% to 55% by weight dry powdered maltodextrin, approximately 20% to 30% by weight dry powdered starch, and approximately 1,8% to 3.8% by weight dry powdered guar gum.

It is a further object of the present invention to provide a pet food composition wherein the dry ingredients mixture includes 24,38% by weight dry powdered yogurt, 49,37% by weight dry powdered maltodextrin, 24.37% by weight dry powdered starch and 1.88% by weight dry powdered guar gum.

It is also an object of the present invention to provide a pet food composition wherein two cups of the dry ingredients mixture are mixed with eight tablespoons of water.

Other objects and advantages of the present invention will become apparent from the following detailed description, which sets forth certain embodiments of the invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

In accordance with the present invention, pet food compositions in the form of an icing and a frosting compositions for pet food products are disclosed. These compositions provide helpful alternatives for use in the manufacture of pet food products. The frosting and icing are of a desired consistency for spreading, drizzling or dipping. They dry hard and do not melt. In addition, neither the frosting nor the icing requires refrigeration, and both are edible pet food products. In addition, both the frosting and icing are sugar free, and fat free. It is also appreciated the frosting and icing are preferably gluten free. They both take color well and are easy to use (just add water and stir). In addition, neither the frosting nor icing will stain carpets when a pet chews it and drops it.

With regard to the frosting composition, the composition is yogurt (sugar free, & fat free) based. As discussed above, it is also appreciated yogurt used in the frosting composition is preferably gluten free. The frosting composition is smooth and creamy and works exceptionally well for piping, spreading, dipping and drizzling. The yogurt frosting composition of the present invention dries hard and will not melt at room temperature (or even at elevated temperatures). As such, no refrigeration is needed.

The frosting composition includes a dry ingredients mixture composed of approximately 27.5% to 37.5% by weight dry powdered yogurt (sugar free & fat free), approximately 27.5% to 37.5% by weight dry powdered maltodextrin, approximately 27.5% to 37.5% by weight dry powdered corn starch and approximately 2.5% to 4.5% by weight dry powdered guar gum. In accordance with a preferred embodiment, the frosting composition includes a dry ingredient mixture of approximately 32.5% by weight dry powdered yogurt (sugar free & fat free), approximately 32.5% by weight dry powdered maltodextrin, approximately 32.5% by weight dry powdered corn starch and approximately 2.5% by weight dry powdered guar gum. It is appreciated that although corn starch is disclosed in accordance with a preferred embodiment, it has been found. that various other starches may be used in accordance with the present invention. As discussed above, it also appreciated the yogurt used in the frosting composition is preferably gluten free.

Once the dry ingredients mixture is prepared and ready for use by hand mixing the above ingredients together, the dry ingredients mixture is mixed with water (approximately ⅓ cup of water to ⅔ cup of water per 2 cups of the dry ingredients as described below) for subsequent application to cakes, as well as moist or dry pet treats. Where the user desires to pipe, that is, extrude the frosting from a manually actuated tube, two cups of the dry ingredients mixture are mixed with ½ cup of water. The wet mixture is then mixed well by hand or with an electric mixer on the lowest speed. The frosting composition is then ready for piping onto pet cakes and moist or dry pet treats.

Where it is desired to spread the frosting, ½ cup of the dry ingredients mixture is mixed with four teaspoons of water (equivalent to mixing 2 cups of the dry ingredients mixture with ⅓ cup of water). The wet mixture is then mixed well by hand or with an electric mixer on the lowest speed. The frosting composition is then ready for application to pet cakes and moist pet treats.

Finally, and where the user desires to dip or drizzle the frosting composition Onto the pet cakes or onto moist or dry pet treats, two cups of the dry ingredients mixture are mixed with ⅔ cup of water. As with the prior compositions, the wet mixture is then mixed well by hand or with an electric mixer on the lowest speed. The frosting composition is then ready for use in a dipping/drizzling embodiment.

In accordance with an alternate icing composition, the icing composition is also smooth and creamy but is designed to flow more than the frosting composition. This makes the icing ideal for filling large areas that are contained by borders. As with the frosting, the icing dries hard and does not melt at room temperature (or even at elevated temperatures). The icing also requires no refrigeration. The dry ingredients mixture of the icing is composed of dry powdered yogurt (sugar free & fat free) in a quantity of approximately 20% to 30% by weight, dry powdered maltodextrin in a quantity of approximately 45% to 55% by weight, dry powdered corn starch in a quantity of approximately 20% to 30% by weight and dry powdered guar gum in a quantity of approximately 1.8% to 3.8% by weight. More particularly, the dry ingredients mixture of the icing is composed of dry powdered yogurt (sugar free & fat free) in a quantity of 24.38% by weight, dry powdered maltodextrin in a quantity of 49.37% by weight, dry powdered corn starch in a quantity of 24,37% by weight and dry powdered guar gum in a quantity of 1.88% by weight. As with the frosting embodiment, it is appreciated that although corn starch is disclosed in accordance with a preferred embodiment, it has been found that various other starches may be used in accordance with the present invention. As with the frosting embodiment, it is also appreciated the yogurt used in the icing composition is preferably gluten free.

Once the dry ingredients are mixed thoroughly to create the dry ingredients mixture, the dry ingredients mixture is mixed with water, in particular, two cups of the dry ingredients mixture are mixed with eight tablespoons (½ cup of water) of water. The dry ingredients and water are thoroughly mixed and the icing is ready for use,

It is appreciated that after mixing, it may be desirable to add small amounts of additional water where thinner frosting or icing is desired. In addition, coloring may be added to the frosting or icing mixture. It is preferred that powdered food colorings be utilized when it is desired to produce a colored frosting or icing. Gel colorings are preferably avoided as they are glycerin based and adding glycerin to the mixture can prevent the product from fully drying.

The frosting and icing disclosed above provide a healthy and all natural product for the production of pet treats. The frosting/icing dry ingredients mixture is healthy and convenient to use as all that is necessary is the addition of water to dry ingredients.

While the preferred embodiments have been shown and described, it will be understood that there is no intent to limit the invention by such disclosure, but rather, is intended to cover all modifications and alternate constructions falling within the spirit and scope of the invention.

1. A yogurt based pet food composition, comprising a dry ingredients mixture composed of:
dry powdered yogurt;
dry powdered maltodextrin;
dry powdered starch; and
dry powdered guar gum.

2. The yogurt based pet composition according to claim 1, wherein the dry ingredients mixture includes approximately 27.5% to 37.5% by weight dry powdered yogurt, approximately 27.5% to 37.5% by weight dry powdered maltodextrin, approximately 27.5% to 37.5% by weight dry powdered starch and approximately 2.5% to 4.5% by weight dry powdered guar gum.

3. The yogurt based pet composition according to claim 2, wherein the dry ingredients mixture includes approximately 32.5% by weight dry powdered yogurt, approximately 32.5% by weight dry powdered maltodextrin, approximately 32.5% by weight dry powdered starch and approximately 2.5% by weight dry powdered guar gum.

4. The yogurt based pet composition according to claim 1, further including water added to the dry ingredients mixture to achieve a desired consistency.

5. The yogurt based pet composition according to claim 4, wherein two cups of the dry ingredients mixture are mixed with between approximately ⅓ cup water and ⅔ cup water.

6. The yogurt based pet composition according to claim 1, wherein the dry ingredients mixture includes approximately 20% to 30% by weight dry powdered yogurt, approximately 45% to 55% by weight dry powdered maltodextrin, approximately 20% to 30% by weight dry powdered starch, and approximately 1.8% to 3.8% by weight dry powdered guar gum.

7. The yogurt based pet composition according to claim 6, wherein the dry ingredients mixture includes 24.38% by weight dry powdered yogurt, 49.37% by weight dry powdered maltodextrin, 24.37% by weight dry powdered starch and 1.88% by weight dry powdered guar gum.

8. The yogurt based pet composition according to claim 7, further including water added to the dry ingredients mixture to achieve a desired consistency.

9. The yogurt based pet composition according to claim 8, wherein two cups of the dry ingredients mixture are mixed with eight tablespoons of water.
